(19) United States
(12) Patent Application Publication
(10) Pub. No.: US 2013/0049309 A1
(43) Pub. Date: Feb. 28, 2013

(54) Access port seal

(71) Applicant: Graham Brigham, Fort St. John (CA)

(72) Inventor: Graham Brigham, Fort St. John (CA)

(21) Appl. No.: 13/137,568

(22) Filed: Aug. 26, 2011

(51) Int. Cl. F16J 15/10; F16J 15/02

(52) U.S. Cl. 277/641

(57) ABSTRACT

An apparatus and kit for sealing an opening in an insulated covering. The kit comprises a gasket securable around the interior edge of the opening in the insulated covering and an apparatus for sealing the opening. The apparatus comprises a waterproof body locatable within the opening, the body having a periphery therearound and a groove located within the periphery. The groove is sized and shaped to closely and sealably receive the opening or the gasket therein. The gasket may have a slot therein sized to be frictionally received over a sheath layer of the insulated covering.

### BACKGROUND OF THE INVENTION

1. Field of Invention

The present invention relates to plugs in general and in particular for plugs located in insulated coverings to provide access to an interior thereof.

2. Description of Related Art

In many industries, it is frequently necessary to access pipes or other conduits to conduct inspection, maintenance and the like. One difficulty that arises with such pipes and conduits is that they are often insulated to protect the contents of the conduit from adverse weather and the like. In particular, in the oil and gas industry, it is common to provide insulation around such pipes with a sheath of protective sheet metal therearound.

Conventionally, when it has been necessary to provide access to a pipe or the contents thereof which have an insulating layer therearound, a hole has been cut in the sheet metal and the insulation removed from that region to form a cavity for access to the pipe. After the maintenance, inspection or the like has been performed on the pipe, insulation is reinserted into the cavity and a new layer of sheet metal secured over the hole to provide a patch in the original sheet metal. Problematically, such a patch has been unsatisfactory at providing the original level of insulation and protection of the pipe from adverse weather. In particular, such sheet metal patches have been known to leak when subjected to rain or melting snow.

The compromised insulation and protective sheath poses a problem for the insulation under the patch as well as the surrounding region as the insulation typically used for such applications is of a fiberglass batting or other fibrous material. Such materials are known to be intolerant of becoming wet, and being prone to compacting when damp. Such compacting of the insulation impairs the ability of the insulation to adequately insulate the pipe in that location as well as any surrounding regions which also become wet.

An additional difficulty of such patches are that once they are installed, any subsequent removal thereof for future maintenance of inspection will increase the size of the screw holes thereby further increasing the ability of water to enter the insulation.

### SUMMARY OF THE INVENTION

According to a first embodiment of the present invention there is disclosed an apparatus for sealing an opening in an insulated covering comprising a waterproof body locatable within the opening, the body having a periphery therearound and a groove located within the periphery. The groove is sized and shaped to closely and sealably engage the opening.

The body may be formed of a material selected from the group consisting of neoprene, rubber or closed cell foam. The body may have an elongate periphery. The periphery is defined by a pair of spaced apart parallel sides having arcuate ends therebetween.

The groove may have a constant radius. The groove may have a radius of less than ½ inch. The groove may be located in the middle of the peripheral edge.

The apparatus may further comprise a leading surface of the peripheral edge extending from the groove by a distance greater than a trailing surface of the peripheral edge. The leading and trailing surfaces of the peripheral edge may be rounded.

According to a further embodiment of the present invention there is disclosed a kit for sealing an opening in an insulated covering comprising a gasket securable around the interior edge of the opening in the insulated covering and a waterproof body locatable within the opening, the body having a periphery therearound and a groove located within the periphery, the groove being sized and shaped to closely and sealably receive the gasket therein.

The gasket may an outer diameter corresponding to the groove in the sealing body. The gasket may have a length corresponding to a periphery of the hole. The gasket may have a slot therein sized to be frictionally received over a sheath layer of the insulated covering.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an insulated pipe having a hole cut in the insulation for access to the pipe.

FIG. 2 is a perspective view of an apparatus according to a first embodiment of the present invention applied to the hole in the pipe.

FIG. 3 is a cross-sectional view of the apparatus of FIG. 2 as taken along the line 4-4 in FIG. 3.

FIG. 4 is a cross-sectional view of the apparatus of FIG. 2 located within a hole in pipe insulation as taken along the line 5-5 in FIG. 2.

### DETAILED DESCRIPTION

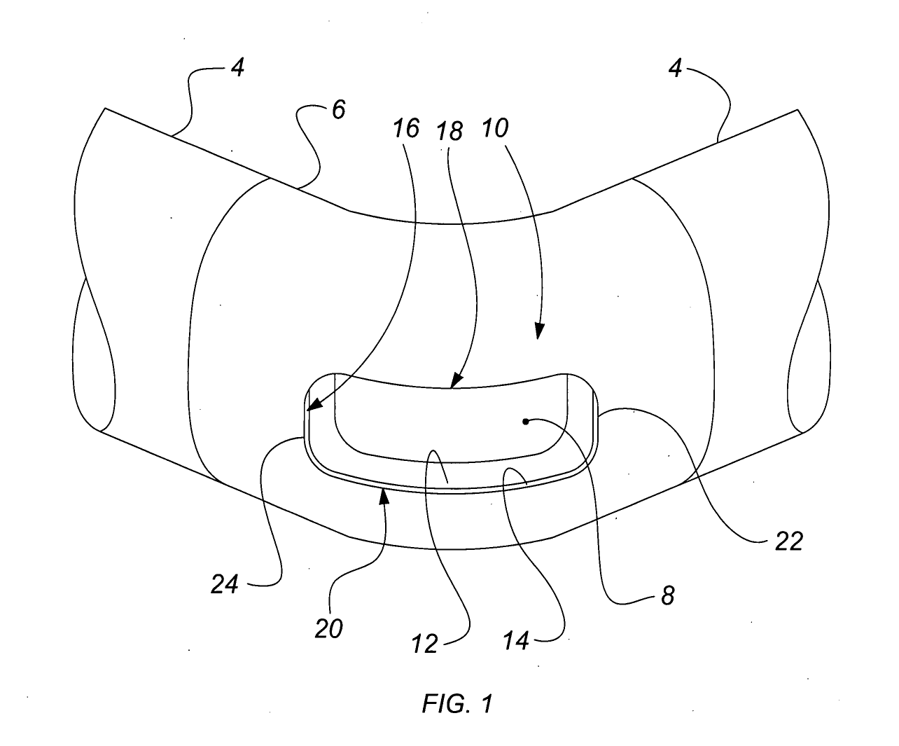

Referring to FIG. 1, an opening through pipe insulation is shown generally at 10. The pipe 8 is surrounded by an insulating layer 12 and a sheath layer 14. The opening is defined by an opening edge 16 having top and bottom straight edges, 18 and 20, respectively, and first and second arcuate portions therebetween, 22 and 24, respectively. As illustrated, the opening 10 may be located within an elbow portion 6 of the pipe and pipe insulation, however it will be appreciated that the opening may also be located within a straight portion 4 or at any other location desired by a user.

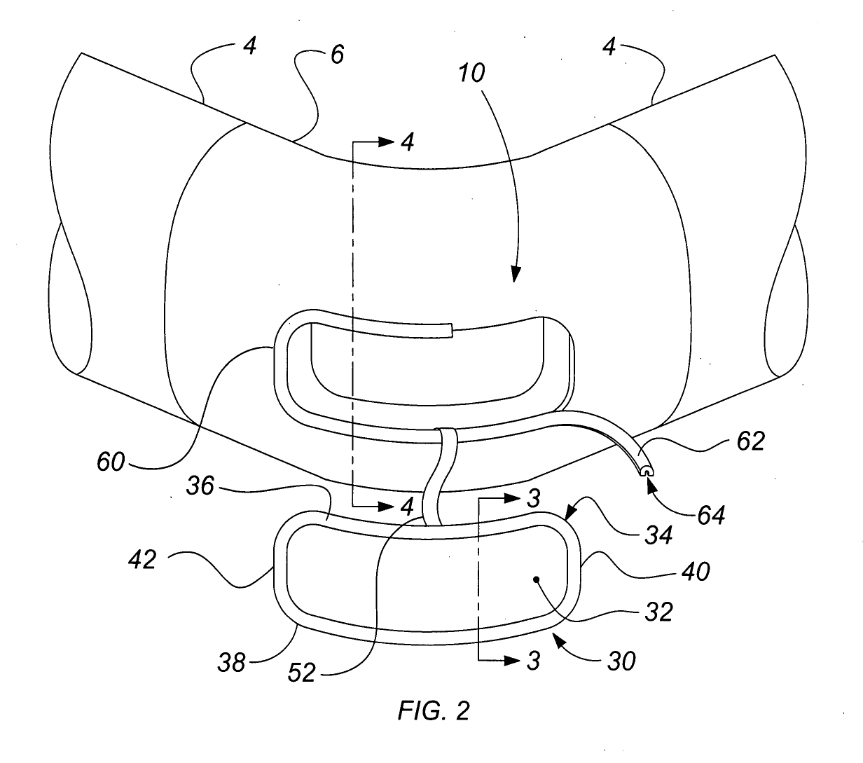

With reference to FIG. 2, the apparatus comprises a plug body 30 sized and shaped to be sealably received within the opening 10. The body comprises a member having front and rear surfaces, 32 and 34, respectively, extending between top and bottom edges 36 and 38 and first and second side arcuate ends, 40 and 42, respectively. Although the body 30 is illustrated and described as having an elongate shaped, it will be appreciated that other shapes may be utilized as well, such as, by way of non-limiting example, oval, circular, rectangular, square, triangular, octagonal or irregular. Additionally, although the body 30 is illustrated as being adapted for insertion into an elbow portion 6, it will be appreciated that the body may be adapted for fitting into a straight portion 4 or other section of the sheath member 14. For use in the straight portion 4, the body may have a straight profile whereas for an elbow portion 6, the body 30 may have a curved profile as illustrated matching or otherwise corresponding to the curvature of the intended section of the sheath layer 14. According to a further embodiment of the present invention, a gasket 60 may be provided around opening edge 16 of the opening as will be further described below.

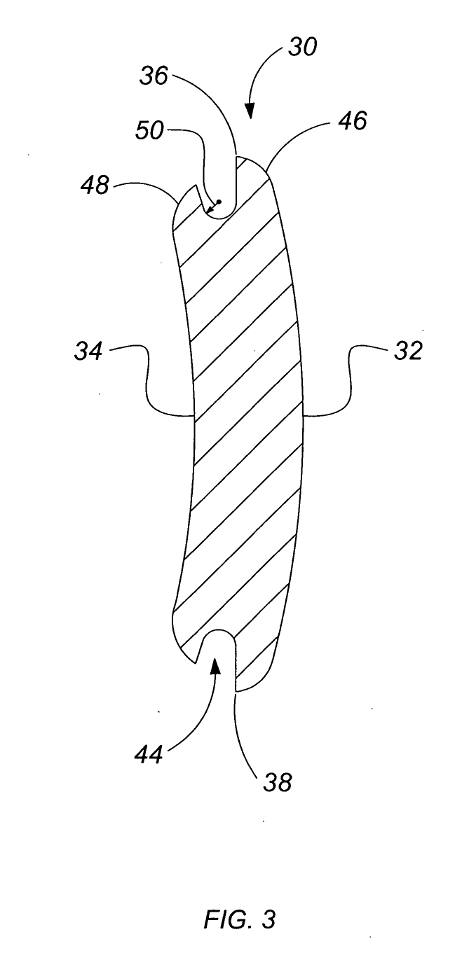

Turning now to FIG. 3, the body 30 is illustrated in cross section. The body 30 has a thickness between the front and rear surfaces 32 and 34 which may be selected to be any suitable thickness for properly sealing the opening 10. By way of non-limiting example, the body may have a thickness of between ½ and 2 inches (12 and 51 mm) with a thickness of approximately 1 inch (25 mm) having been found to be particularly useful. The top and bottom edges 36 and 38 and first and second sides 40 and 42 of the body define a periphery thereof. It will be appreciated that the top and bottom edges 36 and 38 are sized and shaped to correspond to the top and bottom edges 18 and 20 of the opening 10 and the first and second sides 40 and 42 are sized and shaped to correspond to the first and second arcuate portions 22 and 24 of the opening. In particular, it will be appreciated that a user may cut the opening 10 to correspond to the plug body 30 and in some instances may be provided with a cut template (not shown) to guide them in cutting the appropriate sized and shaped opening according to known methods.

As illustrated in FIG. 3, the periphery of the body 30 is defined by the top and bottom edges 36 and 38 and first and second sides 40 and 42 and has a substantially constant profile. The body 30 also includes a groove 44 extending around the periphery and dividing the periphery into a leading and a trailing edge, 46 and 48, respectively. The leading edge 46 is disposed between the front surface 32 and the groove 44 and the trailing edge 48 is disposed between the groove and the rear surface 34 of the body 30. As illustrated, the leading and trailing edge may be rounded although it will be appreciated that other profiles may also be utilized as well, such as by way of non-limiting example, chamfered, beveled or routed. As illustrated, the groove 44 may have a semi-circular cross section having a radius generally indicated at 50 of up to ½ inch (12 mm) with a radius of ¼ inch (6 mm) having been found to be particularly useful although other profiles may be utilized as well, such as, by way of non-limiting example, v-notched, arcuate, rectangular or a slot. Optionally, a strap 52 or other suitable connector may be provided for connecting the body 30 to the sheath layer 14 wherein the strap 52 is secured between the body 30 and an inner surface of the sheath layer 14 by any known means, such as, by way of non-limiting example, screws welding adhesives or the like.

The body 30 may be formed of any suitable waterproof material, such as by way of non-limiting example, neoprene, rubber or closed cell foam. The body 30 may be formed of any known suitable method, such as by way of non-limiting example, casting, machining, utilizing a router or molding.

The gasket 60 may be of any suitable type and in one embodiment may have an outer radiused surface 62 and an inner slot. The outer radiused surface is sized to be sealably engaged within the groove 44 and may therefore have an outer radius of up to ½ inch (12 mm), such as by way of non-limiting example, Edge Trim sold as product ID WRE10B34 by Edge Lok Inc. of Buena Park Calif. The gasket may also include an inner slot 64 sized to be relieved over an edge of the sheath layer 14. The gasket may be provided as a roll which may then be cut by a user or may optionally be provided as part of a kit with a length selected to fully surround a hole as cut according to a provided template.

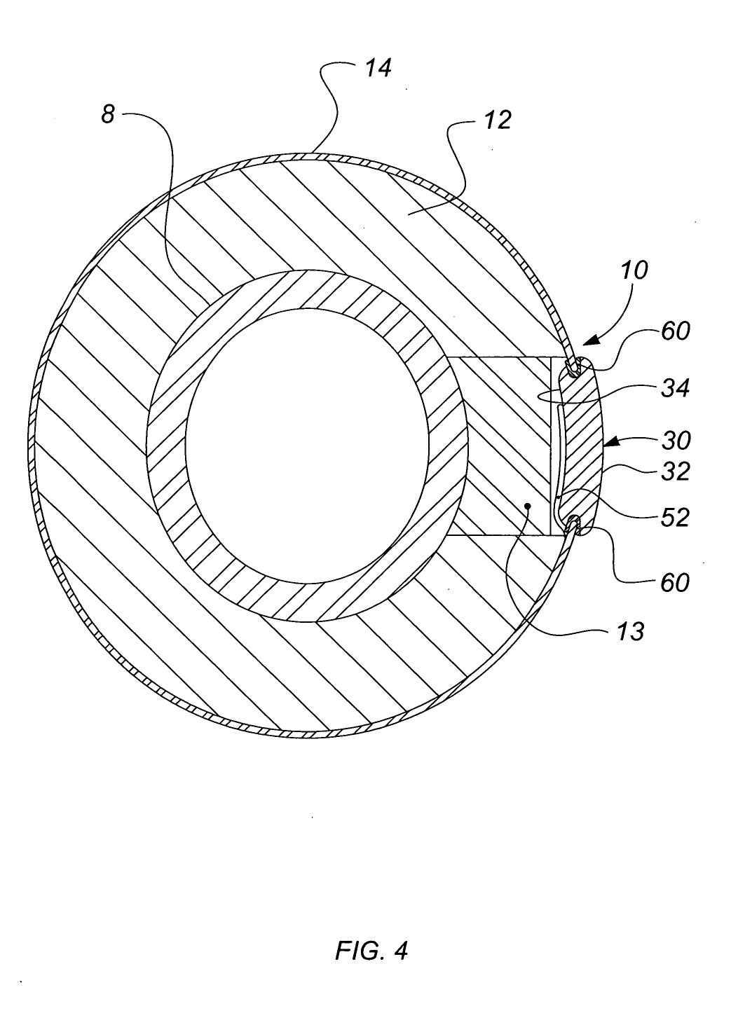

In operation a user may cut an opening 10, optionally with the use of a provided template matched to the body 30 through the sheath layer 14 and insulating layer 12 surrounding a pipe 8. Thereafter the cut out insulation and sheath layer opening portions may be removed to provide access to the pipe for maintenance, inspection and the like. After the user has completed their activities requiring access to the pipe 8, the removed insulation or replacement insulation, generally indicated at 13 in FIG. 4 may then be replaced within the opening. The gasket 60 may then be installed over the edge of the sheath layer and the body 30 inserted such that the gasket 60 is sealably received within the groove as illustrated in FIG. 4. If future access is required to the pipe 8, the body 30 and replacement insulation 13 may be removed to provide access thereto and thereafter reinserted into the opening 10.

While specific embodiments of the invention have been described and illustrated, such embodiments should be considered illustrative of the invention only and not as limiting the invention as construed in accordance with the accompanying claims.

What is claimed is:

1. An apparatus for sealing an opening in an insulated covering, the apparatus comprising a waterproof body locatable within said opening, said body having a periphery therearound and a groove located within said periphery, said groove being sized and shaped to closely and sealably receive an edge of said opening therein.

2. The apparatus of claim 1 wherein said body is formed of a material selected from the group consisting of neoprene, rubber or closed cell foam.

3. The apparatus of claim 1 wherein said body has an elongate periphery.

4. The apparatus of claim 1 wherein said periphery is defined by a pair of spaced apart parallel sides having arcuate ends therebetween.

5. The apparatus of claim 1 wherein said groove has a constant radius.

6. The apparatus of claim 5 wherein said groove has a radius of less than ½ inch.

7. The apparatus of claim 1 wherein said groove is located in the middle of said peripheral edge.

8. The apparatus of claim 7 further comprising a leading surface of said peripheral edge extending from said groove by a distance greater than a trailing surface of said peripheral edge.

9. The apparatus of claim 8 wherein said leading and trailing surfaces peripheral edge are rounded.

10. A kit for sealing an opening in an insulated covering, the kit comprising:
a gasket securable around the interior edge of said opening in said insulated covering; and
a waterproof body locatable within said opening, said body having a periphery therearound and a groove located within said periphery, said groove being sized and shaped to closely and sealably receive said gasket therein.

11. The kit of claim 10 wherein said gasket has an outer diameter corresponding to said groove in said sealing body.

12. The kit of claim 10 wherein said gasket has a length corresponding to a periphery of said hole.

13. The kit of claim 12 wherein said gasket has a slot therein sized to be frictionally received over a sheath layer of said insulated covering.
